(19) United States
(12) Patent Application Publication
(10) Pub. No.: US 2005/0033673 A1
(43) Pub. Date: Feb. 10, 2005

(54) Process for funding multi-unit real estate projects with unit sales that pay-off the project loan at construction completion

(76) Inventor: Robert Lionel Graham, San Diego, CA (US)

Correspondence Address: ROBERT LIONEL GRAHAM, 1604 Yost Drive, San Diego, CA, 92109, US

(21) Appl. No.: 10/637,954

(22) Filed: Aug. 7, 2003

(51) Int. Cl. G06F 17/60

(52) U.S. Cl. 705/35

(57) ABSTRACT

A process for funding construction or conversion of multi-unit real estate projects with a project loan credit enhanced by commitments to purchase individual units at discount prices with unit purchases requiring re-purchase contracts to give developer opportunity to profit from retail unit re-sales, comprising steps of obtaining unit purchase commitments with re-purchase contracts prior to construction start to guaranty project loan pay-off on completion, paying-off project loan upon completion from closing unit sale commitments, and re-selling those units at retail. This process eliminates risks of developer's loss and project loan foreclosure after construction completion and spreads those risks to one buyer per unit. Developers can more readily get 100% project loans, better provide unit loans and earlier closing to retail unit buyers, and thus build more projects not now fundable with project lender restrictions.

### BACKGROUND OF THE INVENTION

The Present Invention is similar in purpose and process to the applicant's Prior Invention, (Patent Application to the United States Patent and Trademark Office application Ser. No. 10/175,213, Filing Date: Jun. 20, 2002, GRP ART Unit: 3629) which Prior Invention relates generally to the field of real estate financing and more specifically to a process for funding the construction or conversion of multi-unit real estate projects, each with proceeds from sales of individual units therein at discount prices to entice quick funding by deferring the developer's profit, with each such unit sale at discount including a unit re-sale contract so that the developer might have the opportunity of profiting on the re-sales of those units.

The Present Invention likewise provides a similar process for funding the construction or conversion of multi-unit real estate projects with many of the same benefits as, but somewhat with a simpler process than, the applicant's Prior Invention, whereby in the Present Invention, the risks of completing the project construction are separated from the risks of selling completed units during the retail unit sales period. Rather than providing project funding for construction directly from wholesale unit buyers as in the Prior Invention, the process described in the Present Invention provides that such funding for construction is provided from a Project Lender. Thus, the need for Unit Completion Guarantors, as described in the Prior Invention, is eliminated because the Wholesale Unit Buyers will close on their Unit Purchase Commitments only at project completion. Thus, in the Present Invention, the risk of construction completion is the Developer's, but on project completion, the unit sale risk transfers to the unit buyers, thus providing the benefits described in the Prior Invention, but simplifying the process by eliminating the Unit Buyers' risks entailed in completing construction that the Prior Invention included.

To provide the Developer with the benefit of making the Project Loan more readily available without the need for Financial Partners and to make it less expensive, the process described in the Present Invention provides that the Project Lender will loan the Developer up to 100% of construction or conversion costs because the Project Loan will be guaranteed or credit enhanced, not only by the developer's credit and ability to complete the project, but also by the commitments from Unit Buyers, made before or at construction start, to buy individual units in the project so that the aggregate of their purchase prices, perhaps supplemented by the Developer's separate funds, will be sufficient to pay-off the Project Loan upon construction or conversion completion. To further guaranty that the Project Loan will be paid-off with closings of unit purchases, a Take-out Funding Commitment could be offered to the Project Lender, and the Take-out Funding Guarantor would have the Unit Purchase Commitments to secure its Take-out Funding Commitment. Thus, the process described in the Present Invention avoids the complexity and extra cost of many individual Unit Lenders dealing with many individual Unit Buyers during the project construction stage and the need for Construction Completion Guaranties for the Unit Buyers as was previously described in the Prior Invention. However, to the extent that Unit Buyers permit the Developer to use any portion of their purchase deposit funds for construction or conversion, they would incur the risks of project completion and may still use Construction Completion Guaranties.

Present Project Lenders hesitate and rarely make construction or conversion loans for multi-unit complexes without financial guaranties and substantial equity investments to guaranty that their project loans will be timely repaid. These credit enhancements insure the Project Lender against not only the risks of construction completion, but more so, they insure against the market risk that the units might not sell quick enough or at high enough prices to timely pay-off the Project Loan. If the Developer so fails to sell the Units, the Project Lender would be forced to foreclose, and if the Financial Guarantors or a bidder at the foreclosure sale did not pay-off the Project Loan, the Project Lender would then have to take the project and would then have to rent the units and sell the project at its rental value to recoup its invested project loan proceeds. Because of this possibility, present Project Lenders now prohibit closing of any unit sales until they are sure that all the units will sell at high enough prices and quickly enough to timely pay-off the Project Loan. The Project Lender must avoid any individual unit ownership because that would eliminate its option of selling the whole project as a rental project as would be necessary if unit sales failed to timely provide enough funds to repay the Project Loan.

Purchase commitments from Wholesale Unit Buyers to buy the number of units needed to pay-off the Project loan on construction completion guaranties pay-off of the Project Loan needed to build the Project and greatly enhances the Developer's ability to obtain a Project loan without the need for Financial Partners to guaranty the Project Lender against loss due to market downturn and the resulting inability to timely sell units at high enough prices.

Moreover, the availability of a Take-out Funding Commitment backed by those Unit Purchase Commitments will simplify the guaranty to the Project Lender and more surely eliminate the Developer's need for Financial Partners and invested equity.

Also, permitting the Developer to use part of the Wholesale Unit Buyers' funds for construction is an option that will reduce the amount of the Project loan, thus making project construction funding that much more economical for the Developer.

The Present Invention describes a simplified process of project funding wherein the Project Lender's loan is paid-off at construction completion by closing of Unit Buyers' Purchase Commitments pledged to the Project Lender, yet preserves the benefits described in the Prior Invention and provides these additional benefits:
1. The Wholesale Unit Buyers' funds are not exposed to loss because of construction delays or failure to complete the unit or the Project's amenities because the Unit Buyers do not close on the Unit Purchase Commitments until and contingent upon construction completion,
2. Risk of construction completion is kept with the Developer who has control of the Project's construction.
3. Unit sales to Retail Unit Buyers during construction can still be committed despite the pre-sale restriction imposed by the Project Lender because the Project loan is guaranteed to be paid-off on construction completion by firm commitments to buy units from Wholesale Unit Buyers sufficient in amount to pay-off the Project Loan.
4. The cost of the Project Loan is reduced and its availability is enhanced because the market risk of selling the Units is eliminated by providing the Wholesale and Retail Unit Buyers' commitments to purchase all Units needed to pay-off the Project Loan on completion.
5. The cost of the Project Loan can be further reduced and its availability further enhanced by providing a Take-out Funding Commitment from a single credit-worthy Take-Out Funding Guarantor whose commitment would be backed by those commitments from the Wholesale and Retail Unit Buyers to purchase Units on completion.
   What is New:
1. Firm commitments from Wholesale Unit Buyers to purchase units, subject to Re-Purchase Contracts or options, made at or before initial funding of the Project Loan in an aggregate amount sufficient to pay-off the Project Loan on Project completion being used to guaranty pay-off of the Project Loan.
2. The inclusion of Unit Re-Purchase Contracts or options and Unit Leases to permit the Developer or the Re-Purchase Contract Buyer(s) or option holder(s) the ability to retain the right to control of the Unit(s) and the right to potential profit on re-sale of the Units to Retail Unit Buyers.
   What is Not New:
1. The Developer's obtaining construction funds from a Project loan is a present-existing and familiar process.
2. A take-out funding commitment from a single credit-worthy guarantor to guaranty to pay-off a Project Lender.

### BRIEF SUMMARY OF THE PRESENT INVENTION

As stated in the Prior Invention, the primary object of the invention is to transfer the risk of multi-unit real estate Project construction and conversion from one Developer and its Financial Partners taking the risk on all Units in a Project to a Project funding structure in which many individual Unit Buyers each take the risk on only one Unit each.

The primary object of the Present Invention is to transfer the market Unit sell-out risk, but not the construction completion risk, of multi-unit real estate Project construction and conversion from one Developer and its Financial Partners taking the risk that all Units in a Project at a high enough price and soon enough to timely pay-off the Project Loan to a Project funding structure in which many individual Unit Buyers each take such Unit sell-out risk on only one Unit each so as to:
Increase availability of funding for construction or conversion of multi-unit real estate Projects,
Lower the cost of Units in multi-unit real estate Projects or increase the Developers' profits therein,
Increase feasibility of building such multi-unit Projects in smaller markets, lower-income areas and outlying locations;
Provide smaller investors with real estate investments over which they can have more control and which have lower risks, and
Provide Retail Unit Buyers with availability of earlier closing dates and Unit Loans for their Unit purchases earlier than otherwise would be available from present institutional lenders.

To achieve the primary object, the process described in the Present Invention provides the Developer with Unit Purchase Commitments before start of construction so that the Developer can use them to credit enhance the Project Loan so the Developer can get the Project Loan without the need for Financial Partners or equity investment. To further increase the availability and reduce the cost of the Project Loan, a credit-worthy Take-out Funding Guarantor could give the Project Lender a Take-out Funding Commitment backed by the Unit Purchase Commitments.

To minimize the risks to the Unit Buyers, the process described in the Present Invention provides that the Unit Buyers would close and pay for their Unit purchases only at and contingent upon their Unit's completion so as to:
Remove the construction completion risk from Unit Buyers to the extent that they withhold their purchase funds from the Developer until Unit completion,
Give the option to the Unit Buyers to permit the Developer to use part of their purchase funds for Unit construction, and
Eliminate the need for Unit Completion Guarantees to the extent that Unit Buyers pay for their Units at and contingent upon the Unit's construction completion.

### OBJECTS OF THE PRESENT INVENTION

The object of the Prior Invention is to more readily provide Developers with 100% of Project construction or conversion funds and marketing and financial costs, all from Wholesale Unit Sales by offering them each at a lower price by the Developer deferring its profit until Retail Unit Sales close.

The object of the Present Invention is provide the benefits of the Prior Invention but to remove the Unit Buyers' construction completion risk, wholly or partially, by delaying closing of Unit purchases until, and contingent on, Unit construction completion.

Another object of the Present Invention is to use the Unit Purchase Commitments from the Wholesale and Retail Unit Buyers to credit enhance the Project Loan and thus assist the Developer in obtaining a Project Loan more readily, at a lower cost and without the need for Financial Partners or equity investment.

A further object of the Present Invention is to provide a Take-out Funding Commitment backed by the Unit Purchase Commitments to pay-off the Project Loan so as to further assist the Developer in obtaining a Project Loan more readily, at lower the cost and without the need for Financial Partners or equity investment.

A further object of the Present Invention is to simplify the Project funding process by eliminating the need for Unit Completion Guarantees by wholly or partially delaying the obligation of the Unit Buyers to close their Unit Purchase Commitments until, and contingent upon, Unit construction completion, and

Still another object of the Present Invention is to make Unit Loans to Wholesale and Retail Unit Buyers more attractive to conventional lenders by eliminating the construction period from the loan period.

Other objects and advantages of the Present Invention will become apparent from the following description, taken in connection with the accompanying drawing, wherein, by way of illustration and example, an embodiment of the Present Invention is disclosed.

### BRIEF DESCRIPTION OF THE DRAWINGS

The drawing constitutes a part of this specification and includes exemplary embodiments to the Present Invention, which may be embodied in various forms. It is to be understood that in some instances various aspects of the invention may be shown exaggerated or enlarged to facilitate an understanding of the invention.

FIG. 1 is a flow chart of the Project Funding Process in accordance with a preferred embodiment of the Present Invention showing the steps, wherein the ten 10 types of Parties enter into nine (9) types of Agreements and execute nine (9) types of Steps leading to ten (10) types of Events to accomplish Project funding; these Parties, Agreements, Events and Steps are all illustrated on FIG. 1 attached to the Present Invention patent application and are enumerated as follows:

STEPS

| | |
|---|---|
| S1 | P1 and P2 determine the Project Funding Process, Unit Sale |
| | Prices and Project Costs |
| S2 | P1 completes the Project ready to build |
| S3 | P1 and P3 market and get Unit Purchase Commitments A3s |
| | and A4s from P4as and P4bs |
| S4 | P7s process Unit Loans A7s for P4as and P4bs |
| S5 | P5 confirms Unit Purchase Commitments A3s and A4s and |
| | Unit Loan Commitments A5s to back-up its Take-out Funding |
| | Commitment A2 |
| S6 | P8 builds the Project to completion E4 |
| S7 | P3 continues to Market and Sell Units to P4bs |
| S8 | P10s make monthly Unit Lease Payments and Re-Purchase |
| | Contract Payments |
| S9 | Unit(s), Profit(s), Unit Loan pay-off(s) delivered on Re-Sale(s) |
| | of Wholesale Buyer(s)' Unit(s) |

PARTIES:

| | |
|---|---|
| P1 | Developer |
| P2 | Plan Administrator |
| P3 | Marketing/Sales Team |
| P4a | Wholesale Unit Buyer(s) |
| P4b | Retail Unit Buyer(s) |
| P5 | Take-out Funding Guarantor |
| P6 | Project Lender |
| P7 | Unit Loan Lender(s) |
| P8 | Building Team |
| P9 | Owners' Association |
| P10 | Unit Re-Purchase Contract Buyer(s) |

AGREEMENTS:

| | |
|---|---|
| A1 | Funding Plan Agreement |
| A2 | Take-out Funding Commitment |
| A3 | Wholesale Unit Purchase Commitment(s) |
| A4 | Retail Unit Purchase Commitment(s) |
| A5 | Unit Loan Commitment(s) |
| A6 | Project Loan |
| A7 | Unit Loan(s) |
| A8 | Re-Purchase Contract(s) |
| A9 | Unit Lease(s) |

EVENTS:

| | |
|---|---|
| E1 | Funding Plan Agreed |
| E2 | Take-out Funding Commitment Made |
| E3 | Project Loan Funded and Construction |
| | Started |
| E4 | Construction Completed |
| E5 | All Wholesale and Retail Unit Sales Closed to |
| | pay-off the Project Loan |
| E6 | Owners' Association takes-over operation of |
| | the Project |
| E7 | Re-Purchase Contract(s) activated and Unit |
| | Lease term(s) started |
| E8 | Wholesale Unit Buyer(s)' Unit(s) Re-Sold on |
| | Closing of Re-Purchase Contract(s) |
| E9 | Retail Unit Buyer(s) assumes Unit Loan(s) or |
| | Unit Loan(s) is paid-off |
| E10 | Re-Purchase Contract(s) Cancelled |

### DETAILED DESCRIPTION OF THE PREFERRED EMBODIMENTS

Detailed descriptions of the preferred embodiments are provided herein. It is to be understood, however, that Present Invention may be embodied in various forms. Therefore, specific details disclosed herein are not to be interpreted as limiting the scope of the invention to the particular form set forth, but rather, it is intended as a basis for the claims so as to include such alternatives, modifications and equivalents as may be included within the spirit and scope of the invention, and as a representative basis for teaching one skilled in the art to employ the Present Invention in virtually any appropriately detailed process, method, system, structure or manner.

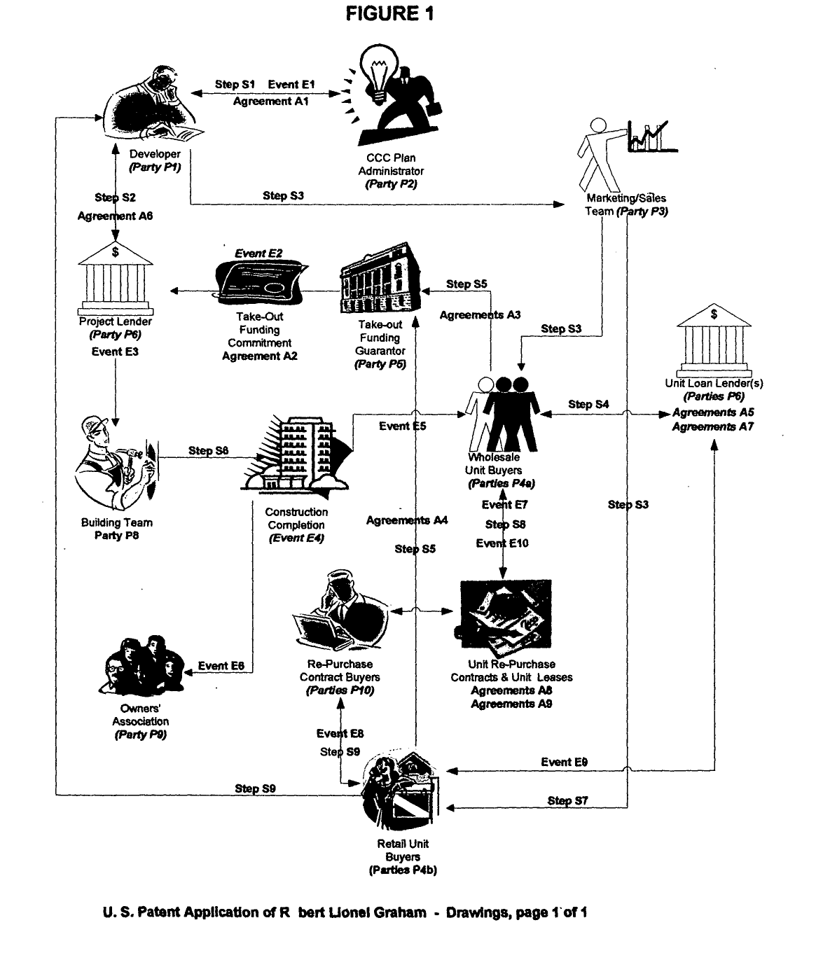

In accordance with a preferred embodiment of the invention, there is disclosed on FIG. 1 a process for funding the construction or conversion of multi-unit real estate projects, especially residential condominium complexes, each with a Project Loan A6 obtained with the credit enhancement provided by Unit Purchase Commitments A3s and A4s and perhaps also a Take-out Funding Commitment A2 secured by those Unit Purchase Commitments A3 & A4. Quickly obtaining the Wholesale Unit Purchase Commitments A3s is made easier and quicker by offering Units at discount prices, with each such purchase by a Wholesale Unit Buyer P4a requiring a Unit Re-Purchase Contract or option A8 and perhaps a Unit Lease A9 so that the Developer P1 or Re-Purchase Contract Buyer or option holders P10s retain the opportunity to realize profits on Re-Sale E8 of those Units to Retail Unit Buyers P4bs.

To accomplish the functions of the Present Invention, FIG. 1 shows how the Present Invention process proceeds, comprising four 4 phases:

Phase 1˜Plan Agreement: In accordance with the primary function of the Present Invention process, in its preferred embodiment, the Plan Administrator P2 defines S1 the project funding process and defines, with input from the Developer P1, the unit sale prices and project costs as described in the Present Invention. The Developer P1 then presents a Project ready to build S2, usually with permits, plans and studies approved, unit prices scheduled, construction costs confirmed, values and absorption rates appraised, marketing/sales planned and team members in-place. The Plan Administrator P2 then works with the Developer P1 and its Marketing/Sales Team P3 to confirm that the funding plan of the Present Invention process is feasible for this project. Then, the Developer P1 and Plan Administrator P2 enter into E1 a Project Funding Plan Agreement A1 and proceed.

Phase-2˜Unit Sales: Turning again to FIG. 1, the preferred embodiment of the Present Invention process provides that the Marketing/Sales Team P3 then markets S3 units directed by the Developer P1 to get Wholesale Unit Purchase Commitments A3s and Retail Unit Purchase Commitments A4s, sufficient to pay-off the planned Project Loan A6 upon Construction Completion E4. The Plan Administrator P2 also perhaps works with the Developer P1 to get a Take-out Funding Commitment A2 from a credit-worthy Take-out Funding Guarantor P5 in order to lower the cost and increase the availability of the Project Loan A6 sufficient to pay 100% of project costs including marketing, Re-Purchase Contract A8 payments and Unit Lease A9 rents for the projected Unit sales period. The Unit Loan Lenders P7s then process S4 Unit Loans A7 for the Unit Buyers P4 as & P4bs and issue Unit Loan Commitments A5s. If the Developer requires a Take-out Funding Commitment A2, the Developer P1 applies for it and the Take-out Funding Guarantor P5 confirms S5 Unit Purchase Commitments A3s & A4s to secure its Take-out Funding Commitment A2 so that it can make that commitment to the Developer P1 and to the Project Lender P6. To encourage Unit sales to Wholesale Unit Buyers P4 as, the Units are priced at a discount and low enough in order to entice a quick sell-out. The major part of the discount offered is accomplished by deferring the Developer's P1 profit S9. Each Wholesale Unit sale requires a Re-Purchase Contract or option A8 to permit the Developer A1 or the Unit Re-Purchase Contract Buyer or option holder P10 to retain the ability to realize additional profit from Re-Sale E8 of those Units sold to Wholesale Unit Buyers P4as. The Developer P1 or Re-Purchase Contract Buyer or option holder P10 will also get a Unit Lease A9 to control the Unit until either it is Re-Sold E8 or the Re-Purchase Contract or option A8 is Cancelled E10, either by default or by agreement.

Phase-3˜Construction or Conversion: Turning again to FIG. 1, the preferred embodiment of the Present Invention process also provides that when enough Units have been committed to be purchased S3 to enable the Developer P1 to obtain a Project Loan A6 with the credit enhancement of pledging the Unit Purchase Commitments A3s and A4s, and if needed, providing a Take-out Commitment E2, then the Developer P1 will be able to get a Project Loan A6 in an amount of up to 100% of project costs without the need for financial partners who would otherwise be needed to invest equity and guaranty the Project Lender P6 against possible loss if the Units did not timely sell at high enough prices. Upon initial funding of the Project Loan E3, the Developer P1 and its Building Team P8 will build the Project to completion S6, and upon completion E4, the following will occur:
All Wholesale and Retail Unit Buyers P4 as & P4bs will close their Unit purchases and the Developer P1 will use the net proceeds there from to pay-off the Project Loan E5,
Re-Purchase Contracts or option(s) A8s and Unit Lease(s) A9s between Wholesale Unit Buyers P4 as and Unit Re-Purchase Contract Buyer(s) or option holder(s) P10s will be activated E7,
The Project Loan A6 will be paid-off from the proceeds of the Unit Sales E5, perhaps along with Developer's other funds, and
The Owner's Association P9 will take-over operations of the completed Project E6.
   Phase-4˜Re-Sales to Retail Unit Buyers: Turning again to FIG. 1, the preferred embodiment of the Present Invention process also provides that the Marketing/Sales Team P3 then continues to market and sell units to Retail Unit Buyers P4bs and Re-Sells S7 Units owned by Wholesale Unit Buyers P4 as to Retail Unit Buyers P4bs through projected Unit sell-out period E8. Until the closing of each such Unit Re-Sale E8 pursuant the Re-Purchase Contract or option A8, the Unit Re-Purchase Contract Buyer(s) or option holder(s) P10s makes monthly Unit Lease Payments and/or Re-Purchase Contract or option Payments S8s, and if such payments are not timely made, the Re-Purchase Contract or option A8 could be cancelled E10 at the option of the Wholesale Unit Buyer P4a and thereupon the Wholesale Unit Buyer P4a would then be free to rent, sell or use that Unit free of further rights of the Developer P1 or Re-Purchase Contract Buyer or option holder P10. At closing of each re-sale E8, the Retail Unit Buyer P4b will either assume the Unit Loan A7, or pay it off E9 and Unit Profits will be paid to the Wholesale Unit Buyer P4a, the Developer P1 and the Unit Re-Purchase Contract Buyer or option holder P10 according to the terms of the Re-Purchase Contract or option A8.
   Turning again to FIG. 1, the preferred embodiment of the Present Invention process provides further that at any time in the process after pay-off of the Project Loan E5 on Construction Completion E4, Units are available for Re-Sale E8 to Retail Unit Buyers P4bs, so that the Developer P1 and Re-Purchase Contract Buyers or option holders P10s can close Unit sales and Re-Sales E8s to Retail Unit Buyers P4bs, free of restrictions that in conventionally financed projects would have otherwise been imposed by the Project Lender P6.

Unit Loan assumption by Retail Unit Buyer:˜To accomplish another important function of the Present Invention, there is shown also on FIG. 1 that the Present Invention process provides for Unit Loans A7s to Wholesale Unit Buyers P4 as that may be assumed by Retail Unit Buyers P4bs, comprising the steps of:
Wholesale Unit Buyer P4a receives a Unit Loan Commitment A5 from a Unit Loan Lender P7 before Project construction start E3,
Wholesale Unit Buyer P4a closes Unit Purchase E5 on Construction Completion E4,
Re-Purchase Contract Buyer or option holder P10 Re-Sells or assigns the option on the Wholesale Unit Buyer's P4a Unit to a Retail Unit Buyer P4b,
Retail Unit Buyer P4b may assume the Unit Loan A7 for the remainder of its term, permitting the Retail Unit Buyer P4b to finance his/her Unit purchase before conventional unit loans are available from conventional lending sources. That is because conventional unit lenders will not conventionally lend on a unit in a multi-unit project until at least half of the units are owned and occupied by their purchasers.
Because of this early availability of Unit Loans A7s to Retail Unit Buyers P4bs, the Developer P1 or Re-Purchase Contract Buyers or option holders P10s will be able to sell any Unit to a Retail Unit Buyer P4b and close that sale earlier because the Project Lender P6 will have been paid-off on construction completion E5. Without the plan embodied by the Present Invention, the Project Lender's P6 Project Loan A6 would still be a lien on the entire project and the Project Lender P6 would have required delay of the closing of the first retail Unit sale until some, say 50%, of the retail Unit sales to owner-occupiers could be closed together. This is because the Project Lender P6 would, until then, be unsure that the remainder of the units would sell quickly enough and at prices high enough to timely pay-off it's Project Loan P6.
   What is Old and What is New.

Turning again to FIG. 1, the preferred embodiment of the Present Invention process provides the following items that show what is old and already known in existing Project funding processes with a Project Loan P6 and a Developer P1 with Financial Partner(s), and what is new in the Present Invention:

What is old and already known is that a Developer P1 with a Project ready-to-build S2 is required to start the Project funding process,

What is old and already known is that in existing Project funding processes there are requirements of underwriting Project feasibility S1, appraising prospective Unit sales prices, profit potential, costs and quality of the development team.
What is new in the Present Invention is that Re-Purchase Contracts or options A8 are granted to the Re-Purchase Contract Buyers or option holders P10s or to the Developer P1 acting in that capacity in return for discounting the sale price to, and Leasing the Unit A9 from the Wholesale Unit Buyers P4s in order to both entice quicker Unit sales before construction start and to retain the profit potential on Unit re-sales for the Developer P1 and the Re-Purchase Contract Buyers or option holders P10s.
What is also new in the Present Invention is that the Developer P1, or Re-Purchase Contract Buyers or option holders P10s, is relieved of Project Loan default and foreclosure risks due to Units not selling at high enough prices and/or quickly enough to timely pay-off the Project Loan P6 because the pledge of the Unit Purchase Commitments A3s and A4s and Take-out Funding Commitment A2 will result in pay-off of the Project Loan at construction completion E4 as is provided in the process described in the Present Invention.
What is also new in the Present Invention is that the need for Financial Partners to provide equity to guaranty the Project Lender P6 against failure of Unit sales is eliminated and replaced by Unit Purchase Commitments A3s and A4s in order for the Developer P1 to get a Project Loan A6 and retain the right to potential profits on Retail Unit sales E8.

What is old and already know is that in existing project funding processes, the Project Lender P6 will require assurances of Construction Completion E4 from the Developer P1, its financial partners and Building Team P8.

What is old and already known is that in existing Project funding processes, marketing and sales to Retail Unit Buyers P4bs are required for the Developer P1 to realize profit,
What is also new in the Present Invention is that the risk of loss to the Developer P1 after Construction Completion E4 is limited to loss of profit because 100% of land, development and construction costs can be funded by the Project Loan A6, because it is guaranteed before Construction Start E3 to be paid-off on Construction Completion E4 by closing Unit sales pursuant to the Wholesale and Retail Unit Purchase Commitments A3s and A4s, and perhaps additionally guaranteed by a Take-out Funding Commitment A2, even if no Units are sold to Retail Unit Buyers P4bs.
What is new in the Present Invention is that the Project Loan A6 is paid-off at Construction Completion E4, so Retail Unit Buyers P4bs can each independently close their individual Unit purchases:
   Without waiting for release from a Project Lender's P6 lien and pre-sale requirement to be met as is required by Project Lenders P6s in existing Project funding processes, and
   Without threat of Project foreclosure by a Project Lender A6, Retail Unit Buyers P4bs can better plan their finances and occupancy moves.
What is also new in the Present Invention is marketing and sales S3 to Wholesale Unit Buyers P4 as at a discount low enough to entice quick sell-out by deferring Developer's P1 profit S9, each combined with delivery of Re-Purchase Contracts or options A8s and Unit Leases A9s so the Developer P1 or Re-Purchase Contract Buyers or option holders P10s retain control of the Units and the right to realize profits S9 on Retail Unit Sales E8s.
What is also new in the Present Invention is funding of up to 100% of project costs by the Project Lender P6 is far more available and less costly because repayment is secured by Wholesale and Retail Unit Purchase Commitments A3s & A4s, and perhaps a Take-out Funding Commitment A2.
What is most importantly new in the Present Invention is that by requiring Unit Re-Purchase Contracts or options A8s and Unit Leases A9s from Wholesale Unit Buyers P4 as, the Unit Re-Purchase Contract Buyers or option holders P10s, or the Developer P1 acting as such, retain the opportunity to profit from Re-Sales S9s to Retail Unit Buyers P4bs.

What is also old and already known is that in existing Project funding processes, no Unit Loans A7s can be secured by an individual Unit Buyer until the Project Lender P6 agrees to a partial release of that Unit. Unit Loans A7s are thus delayed until the Project Lender's P6 requirement that some, say 50%, of the Units be sold to Retail Unit Buyers P4bs is met before it permits any partial releases of Units from the lien of its Project Loan. These requirements delay closing of sales to Retail Unit Buyers P4bs, increase the Developer's P1 risk of loosing Retail Unit sales because of the unknown time-delay, and require that the Developer P1 to get Financial Partners to further guaranty the Project Lender P6 in order to shorten that delay. All this delay and involvement of Financial Partners increases Project risks and costs and thus prevents Project construction or conversion in all but the most large, established and growing areas.
What is new in the Present Invention is that each Wholesale Unit Buyer P4a will already have received clear title to each individual Unit by closing his/hers/its purchase at construction completion E4, thus any Wholesale Unit Buyer P4a can transfer title immediately on Construction Completion E4 to a Retail Unit Buyer P4b, free from any Project Lender's P6 lien on all Units, because the Project Loan A6 is paid-off at Construction Completion E4 by closing of all Unit sales pursuant to Wholesale and Retail Unit Purchase Commitments A2s & A3s.
What is also new in the Present Invention is that the need for the Developer P1 to get Financial Partners to provide equity and guaranties to the Project Lender A6 to guaranty repayment of the Project Loan A6 after construction completion is replaced by the collateral assignment of the Wholesale and Retail Unit Purchase Commitments A3s & A4s, and if needed, the Take-out Funding Commitment A2, which will better guaranty that the Project Loan A6 will be paid-off E5 at construction completion E4.
What is also new in the Present Invention is that Unit Lenders P7s can get a good first lien on an individual Unit free of foreclosure threat by the Project Lender A6, immediately upon Construction Completion E4 and without waiting for the Project Lender's P6 pre-sale requirement to be met, because the Project Loan A6 is paid-off immediately on Construction Completion E5.

What is old and already known is that in existing Project funding process, a smaller real estate investor's ability to invest in a multi-unit real estate Project is limited to either investment in a very small project or investing as a minority investor in a syndication of a larger project.
What is new in the Present Invention is that an individual small investor can give a Wholesale Unit Purchase Commitment A3 to purchase a single Unit in a multi-unit real estate project prior to its construction, and thus improve his investment position by having ownership of a Unit of real estate without any partners rather than owning a minority interest in a syndication partnership or limited liability company, thus giving the smaller real estate investor:
   More control over his investment,
   More liquidity, and
   Less legal process and delay should there be a default on the Unit Re-Puchase Contract or option A8 or Unit Lease A9.
What is also new in the Present Invention is that the individual small real estate investor doesn't have to take any construction risk, because his Unit Purchase Commitment A3 is conditioned on Construction (or conversion) Completion E4, and closing E5 of his Unit purchase happens only upon Construction Completion E4.
What is also new in the Present Invention is its structure that enables a number of independent Wholesale Unit Buyers' P4 as commitments combined with a Developer P1 to build or convert more Projects and Projects in locations that are otherwise too small or too large or in smaller markets or in lower-income or marginally outlying areas where existing Project Lenders P6 and financial partners find it too risky or cannot profitably underwrite the Unit sales risk in order to provide Project funding. Such small numbers of smaller real estate investors can each take smaller risks, each invest smaller amounts, each enjoy greater control and each have more liquidity in their investments, thus enabling them to more readily take the Unit sales risk, one unit at a time, to credit enhance a Developer's P1 Project Loan A6 making it far more available and less costly.
Most significantly, what is new is that by using the Present Invention process, a Developer P1 in any small community can get funding to build a 10 or so Unit Project by selling the Units up-front at discount to local business people. With appraisals of the Units' sale-value to show the profit potential and with appraisals of the Units' rental-values to cover the Wholesale Unit Buyers' P4 as “down-side” risk, and by noting that their risk will be in buying just one Unit per buyer upon Construction Completion E4, and by providing a Unit Loan A7 to each Unit Buyer P4a, a Developer P1 can get a Project Loan A6 committed with perhaps one presentation at a local business club luncheon. This should result in more condominium Units getting built, quicker and with lower financial risk, cost and delay; and building housing quicker and at lower financial cost is better for everyone.

While the Present Invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for funding construction or conversion of multi-unit real estate projects with a project loan credit enhanced by commitments from a number of independent buyers to purchase individual units therein at discount prices with each such unit purchase requiring a re-purchase contract or option to give the re-purchase contract buyer, which might be the developer, the opportunity to profit form re-sale to retail unit buyers, comprising the steps of:
Obtaining unit purchase commitments with unit re-purchase contracts or options prior to project construction start,
Credit enhancing the project loan by pledging such unit purchase commitments to pay-off the project loan upon construction or conversion completion,
Funding project costs with such project loan and paying it off upon construction or conversion completion with proceeds from closing of Unit sales pursuant to such unit purchase commitments, and
Selling those units to retail unit buyers pursuant to those re-purchase contracts or options.

2. A process as claimed in claim 1 further comprising the steps of:
Issuing a take-out funding commitment based on unit purchase commitments to further guarantee the project lender of pay-off upon construction completion.

3. A process as claimed in claim 1 further comprising the steps of:
Providing unit leases to the re-purchase contract buyers or option holders to permit them to have control and occupancy during the re-purchase option periods.

4. A process as claimed in claim 1 further comprising the steps of:
Re-selling units that have been sold at discount to wholesale unit buyers to retail unit buyers each pursuant to re-purchase contracts or options to re-purchase contract buyers or option holders, including the developer acting as such, so they may realize potential profit.

5. A process as claimed in claim 1 further comprising the steps of:
Closing unit sales to retail unit buyers before sale of any other of the project's units free of project lender restrictions, and

6. A process as claimed in claim 1 further comprising the steps of:
Providing that unit loans to wholesale unit buyers that may be assumed by retail unit buyers to assist in their purchase before conventional unit loans are available to them.
